(19) United States
(12) Patent Application Publication
(10) Pub. No.: US 2017/0316045 A1
(43) Pub. Date: Nov. 2, 2017

(54) READ-AFTER-WRITE CONSISTENCY FOR DERIVED NON-RELATIONAL DATA

(71) Applicant: LinkedIn Corporation, Mountain View, CA (US)

(72) Inventors: Viman Deb, San Jose, CA (US); Nicolette A. Askew, San Francisco, CA (US); Saung C. Li, Sunnyvale, CA (US); Timothy V. Santos, Mountain View, CA (US)

(73) Assignee: LinkedIn Corporation, Mountain View, CA (US)

(21) Appl. No.: 15/142,524

(22) Filed: Apr. 29, 2016

(51) Int. Cl. G06F 17/30

(52) U.S. Cl. CPC G06F 17/30368; G06F 17/30917; G06F 17/30321; G06F 17/3048

(57) ABSTRACT

A system is provided that ensures read-after-write consistency. During operation, the system receives, from a user, a write to a record having a primary key in a master key-value store, wherein the write specifies a secondary key for the record. The system then caches the secondary key and the primary key in a cache entry in a cache, wherein the cache entry is associated with the user. Next, the system applies the write to the master key-value store. Prior to propagation of the write from the master key-value store to a derived key-value store that maps secondary keys to primary keys, the system receives from a given user a query for the record, the query comprising the secondary key and not the primary key. Next the system translates the secondary key to the primary key by querying the cache when the given user is the user.

### BACKGROUND

### Field

The disclosed embodiments relate to non-relational databases. More particularly, a system, apparatus, and methods are provided that ensure read-after-write consistency for clients of non-relational databases with derived tables in environments with multiple colocations.

### Related Art

Software companies that provide online services to users commonly allow those users to manage various types of entities that are stored in non-relational databases. Oftentimes, a user wishes to view an entity immediately after the user creates or modifies the entity at a master table of the non-relational database through an interface (e.g., a web interface or a client application) that is provided by the company. The desired functionality can be referred to as read-after-write consistency.

However, because the interface may not have access to the entity's identifier immediately after its creation and because derived tables may lag the master table, the user may not experience read-after-write consistency from the interface. As a result, the user may have to wait for some time before the user's modifications appear in the interface. Hence, what is needed is a system allows users to manage entities within a non-relational database without the above-described problem(s).

### BRIEF DESCRIPTION OF THE FIGURES

FIG. 1 shows a schematic of a system in accordance with the disclosed embodiments.

FIG. 2 shows a data center that provides read-after-write consistency for derived non-relational data in accordance with the disclosed embodiments.

FIG. 3 shows one or more exemplary data-structures used within a system that provides read-after-write consistency for derived non-relational data in accordance with the disclosed embodiments.

FIG. 4A shows a flowchart illustrating an exemplary process of reading data associated with an entity after creating the entity in accordance with the disclosed embodiments.

FIG. 4B shows a flowchart illustrating an exemplary process of reading data associated with an entity after modifying the entity in accordance with the disclosed embodiments.

FIG. 5 shows a flowchart illustrating an exemplary process of writing to an entity in accordance with the disclosed embodiments.

FIG. 6 shows a flowchart illustrating an exemplary process of reading data associated with an entity in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, flash storage, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The disclosed embodiments provide a method, apparatus, and system that ensure read-after-write consistency when retrieving data from non-relational databases based on derived non-relational data in environments with multiple colocations.

During operation, an online service that is provided by an organization allows users to manage various types of entities, which are stored in one or more non-relational databases of the organization. For example, the online service may be part of a business-oriented online user community where users of the online community (i.e., members) may form connections to further business goals. In particular, the user community may allow each member to manage one or more profiles of companies that the member is affiliated with, and/or profiles of other entities (e.g., profiles of members, profiles of groups).

When a given member modifies an entity through an interface (e.g., a web interface or a client application) that is provided by the organization, a write is made to a non-relational database table that stores entities (i.e., the master table). It should be noted that the organization may maintain one or more other tables derived from the master table at the same non-relational database or at one or more other non-relational databases, wherein the derived tables lag the master table (i.e., writes made to the master table are propagated to derived tables after a delay). In particular, a derived table that maps an entity's secondary key (e.g., a company's universal name, the company's stock symbol, the company's email domain) to the entity's primary key (e.g., an identifier of the company) may be maintained so that entities may be searched using attributes of the entity other than the primary key.

The modification causes a write to be sent to the non-relational database, wherein the write refers to the entity via its primary key and specifies a modification to a secondary key of the entity. Before the write is applied, a cache intercepts the write and creates a cache entry that associates the given member's identifier to both the primary key and the modified secondary key. The write is then applied to the master table.

Before the write is propagated to the derived table, a member initiates a query to the derived table, wherein the query specifies the entity by the secondary key that was modified. The cache intercepts the query and determines whether the member that initiated the query has recently made any modifications to the master table. If the member that initiated the query is the given member, the given member may be attempting to view the recent modification. In response, the cache retrieves the cache entry associated with the given member's identifier, determines that the modified secondary key specified by the query matches the modified secondary key stored in the cache entry, and returns the cache entry's primary key.

If the member that initiated the query is not the given member, the query is forwarded to the derived table after it is determined that the cache does not contain an entry that matches the member's identifier. The secondary key specified by the query is then used to obtain the entity's primary key from the derived table. Once the primary key is obtained, the primary key is used to retrieve the entity from the master table.

Due to the inherent structure of non-relational databases, it may be difficult and/or expensive to implement relational database-style indexes for non-relational databases within a distributed environment. By placing a caching layer in front of one or more derived tables that map secondary keys to primary keys, some embodiments may enable read-after-write consistency. In particular, some embodiments may enable members that (1) recently created a new entity or (2) modified one or more secondary keys of an entity to consistently view the results of their modifications without having to wait for their modifications to propagate throughout the distributed environment.

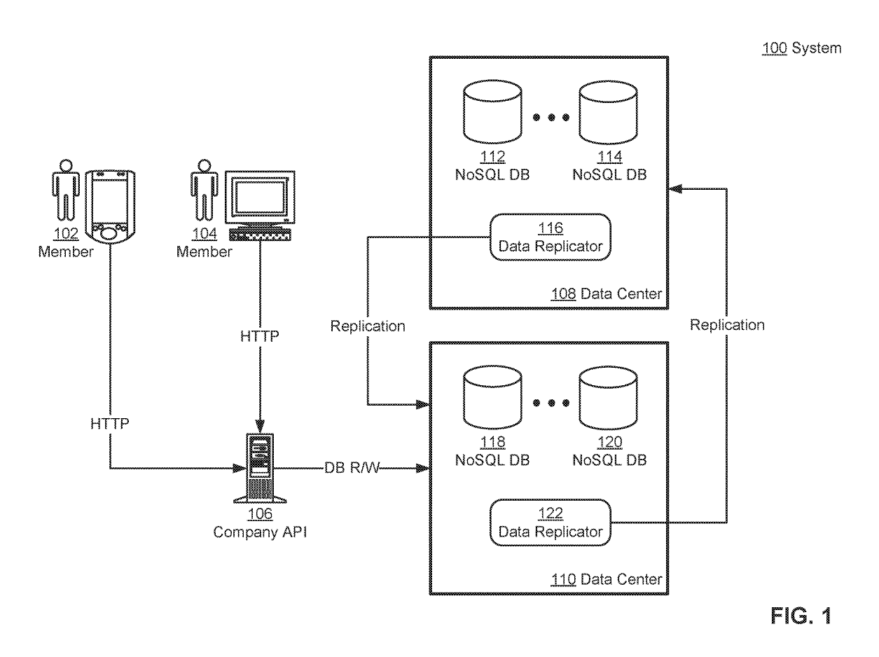

FIG. 1 shows a schematic of a system in accordance with the disclosed embodiments. System 100 corresponds to one or more data centers associated with one or more software programs/applications and includes different components in different embodiments. In the illustrated embodiments, the system includes members 102-104, company application programming interface (API) server 106, data center 108, which includes non-relational (i.e., NoSQL) databases 112-114 and data replicator 116, and data center 110, which includes non-relational databases 118-120 and data replicator 122.

Members 102-104 may each correspond to an individual who has created a user account at a user community and uses a personal computing device (e.g., a smartphone, a tablet, and/or a laptop) to login to the user account. By logging into the user community, a member may interact with other members of the user community and/or access resources through one or more webpages and/or online services provided by the user community. The provision of these webpages and/or online services may be handled by the user community's infrastructure, which may include data centers 108-110 and company API server 106. A data center may house one or more machines (i.e., servers, computers) for serving the webpages and/or online services and storing data.

In particular, the user community may allow a member to create and/or manage one or more profiles of companies and/or other entities that the member is affiliated with, wherein each profile is viewable by other members of the user community. Each company profile may be backed by a company entity (i.e., company record) stored in a non-relational database table (i.e., the master table). The company profile may contain attributes of the company (e.g., the company's universal name, the company's stock symbol, the company's email domain).

When the member modifies the company's profile through an interface provided by the user community (e.g., a client application that executes on a smartphone, a webpage accessed via a browser), the interface may make one or more calls (e.g., requests) to company API server 106. Company API server 106 may correspond to a representational state transfer (RESTful) API that exposes, to interfaces that enables members to manage and/or view company profiles, functions for creating, modifying, and deleting company profiles stored at the master table. Requests made to the company API server may cause the server to make one or more writes and/or queries to the master table. Thus, company API server 106 serves as a level of indirection between the interfaces and the non-relational database tables, thereby promoting modularity and protecting the tables from outside tampering.

Data centers 108-110 may each house one or more machines (i.e., servers, computers) on which software applications are executed. The servers may be organized into one or more clusters of machines, wherein servers within a cluster share one or more common properties with one another (e.g., the servers execute the same software application). In some embodiments, the total number of servers may number in the thousands, with each data center having many clusters and each cluster having many servers. Data centers 108-110 may each house one or more servers for running one or more non-relational databases. In particular, data center 108 supports non-relational databases 112-114 and data center 110 supports non-relational databases 118-120.

A non-relational database may refer to a database that provides one or more ways of storing and retrieving data that is modeled in means other than the tabular relations used in relational databases or Relational Database Management Systems (RDBMSs). Non-relational databases may be preferred over relational databases because (1) it may be easier to evolve schemas in non-relational database tables, (2) failover between data centers with non-relational databases may not require downtime or may require less downtime, and (3) RDMBSs often operate on expensive hardware and often require expensive annual software licenses.

In particular, non-relational databases 112-114 and 118-120 may correspond to Espresso Databases that are each run by a cluster of servers (i.e., an Espresso cluster). Espresso is an online, distributed, fault-tolerant non-relational database that is capable serving as the source of truth for hundreds of terabytes of data and serving millions of records per second. Espresso organizes data into a hierarchy that includes databases, tables, and records (i.e., documents). Databases in Espresso, which may be conceptually similar to RDBMSs, may contain one or more tables. A table may correspond to a container of homogenously typed documents and may be defined by a table schema. The table schema may define a key-structure that discloses how documents are accessed, wherein each document that is stored in the table is uniquely identified by a primary key.

Each document may be stored using a data serialization system such as Apache Avro. For example, when a company profile is created by a member, the corresponding data is stored as a document within the master table and a unique primary key is assigned to the newly created document. The primary key (e.g., the company identifier) may be used to access the company profile from the master table via a RESTful API that is provided by the Espresso cluster.

In particular, company API 106 may make queries and writes to the master table via the RESTful API provided by Espresso. Writes that create or modify company profile(s) at the master table may correspond to Hypertext Transfer Protocol (HTTP) PUT and/or POST requests that are sent by the company API. Queries to the master table or any of the derived tables may correspond to HTTP GET requests that are sent by the company API. Writes that remove company profiles from the master table may correspond to HTTP DELETE requests that are sent by the company API.

Attributes of the company may be stored in specific fields of the company profile. For example, the universal name of the company may be stored in a field with the fieldname “uname,” the stock ticker symbol of the company may be stored in another field with the fieldname “ssymbol,” and the email domain of the company may be stored in another field with field name “email.” In some embodiments, the universal name of a company may be derived from the company's name.

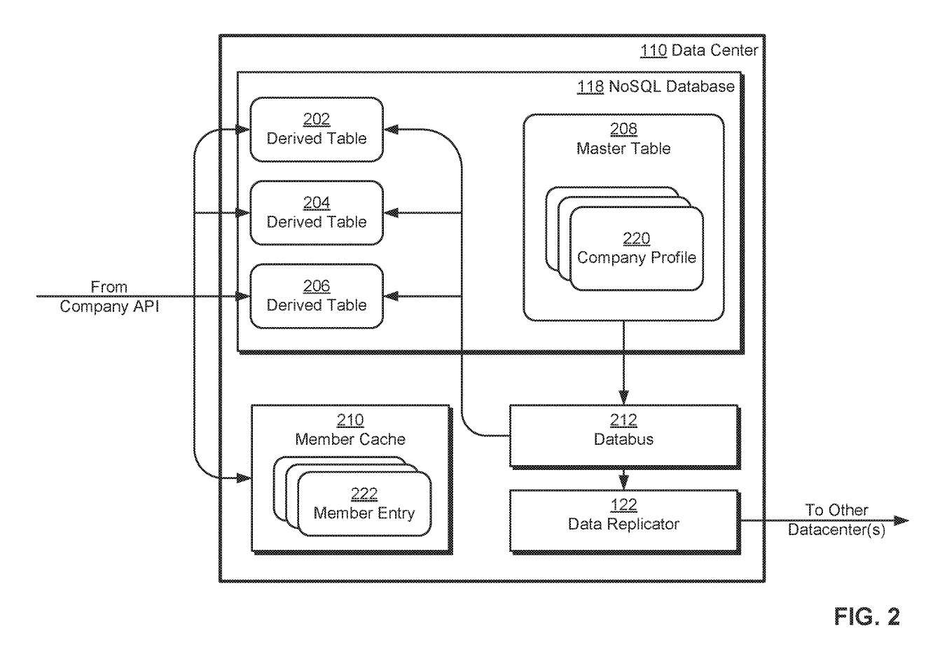

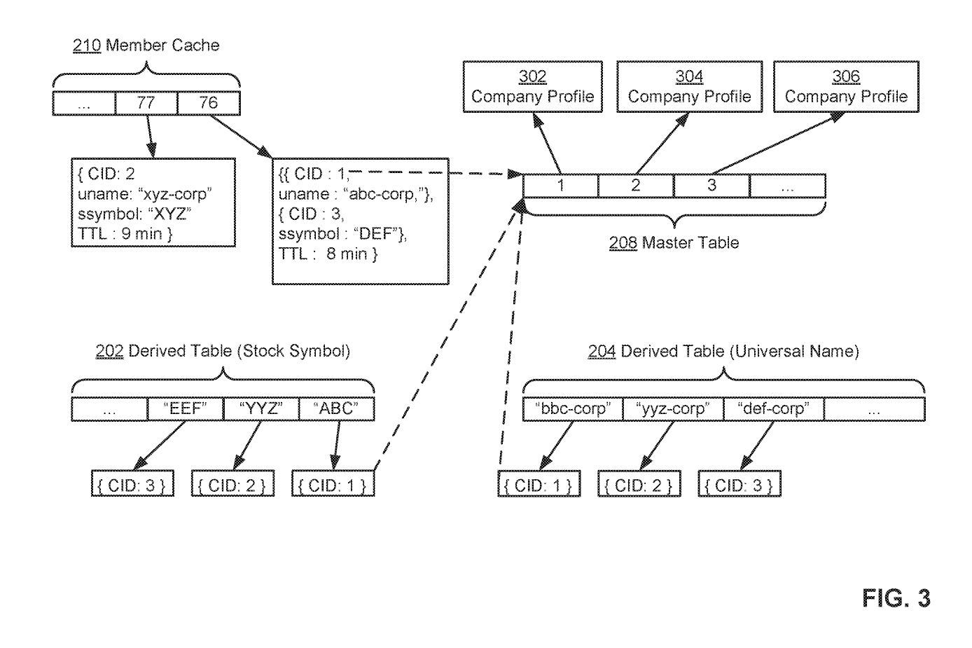

It should be noted, however, that because the structure of Espresso tables are similar to that of a key-value store, it may be expensive to select a particular document from an Espresso table using any attribute other than the attribute that is designated as the table's primary key (e.g., company identifier). For example, without the assistance of other tables derived from the master table (i.e., derived tables), attempting to obtain a particular company record from the master table without the company identifier may be cost-prohibitive. In a sense, derived tables in non-relational databases may serve as an analog to indexes in RDBMSs. Derived tables are discussed in further detail below with respect to FIGS. 2-3.

To safeguard data from hardware failures and natural disasters, the organization that operates data centers 108-110 may configure its Espresso databases to be co-located across data centers in different geographic locations. In particular, a data replication service may forward commits between Espresso clusters housed in different data centers. For example, the master table may have replicas of its data in both data center 108 and data center 110. Thus, when member 102 creates a new company profile, if member 102 is geographically proximate to data center 110, the write may be applied to non-relational database 118 (assuming the local copy of the master table is stored in non-relational database 118). Next, data replicator 122 may forward the write to data center 108. Likewise, if a write is applied to a non-relational database in data center 108, data replicator 116 may forward the write to data center 110. In particular, data replicators 116-118 may each correspond to a set of one or more clustered nodes (e.g., servers), wherein each node is assigned a particular portion of an Espresso database to replicate.

FIG. 2 shows a data center that provides read-after-write consistency for derived non-relational data (i.e., data stored in one or more derived tables of a non-relational database) in accordance with the disclosed embodiments. In the illustrated embodiments, data center 110 includes non-relational database 118, member cache 210, databus 212, and data replicator 122. Non-relational database 118 includes derived tables 202-206 and master table 208.

As explained previously, master table 208 may correspond to an Espresso table that stores one or more company profiles (e.g., company profiles 220). To access a particular company profile from the master table efficiently, a query would need to specify the company profile's primary key (i.e., the company identifier). However, the company identifier may not always be available. For example, in situations where a member requests the creation of a company profile, the company identifier may not be available to the client-facing interface or the company API 106 until sometime after the company profile is created at the master table. If the member requests to view the newly created company profile prior to this point (i.e., the member requests a read-after-write), the company API would need to rely on one of derived tables 202-206.

Each company profile may include one or more company attributes (e.g., the company's universal name, the company's stock symbol) that uniquely identify the company profile and can serve as secondary keys. Because the member may have these company attributes before the point and/or at the point the company profile is created, company API 106 may use secondary keys in tandem with derived tables to access the newly created company profile.

Derived tables 202-206 may each correspond to an Espresso table that maps a particular secondary key for each company profile to a company identifier. For example, for each company profile, (1) derived table 202 may store the company profile's company identifier as a record and assign the company profile's stock ticker symbol to be the primary key that refers to the record, (2) derived table 204 may store the company profile's company identifier as a record and assign the company profile's universal name to be the primary key that refers to the record and (3) derived table 206 may store the company profile's company identifier as a record and assign the company profile's email domain to be the primary key that refers to the record. Thus, when a member wishes to view a newly created company profile before its company identifier is available, the company API may first make a query to derived table 204 to translate the company profile's universal name to the company identifier and then use the identifier to access the company profile from master table 208.

Data stored in derived tables 202-206 is derived from master table 208 via databus 212. Databus 212 may correspond to a real-time change data capture system that is used by data centers as a change capture mechanism for propagating transactions (i.e., writes) to a source table in the order the transactions were committed. For example, when company profile 220 is created at master table 208, databus 212 may propagate this write to derived tables 202-206 via one of more databus change events. In response to receiving the write, (1) derived table 202 may map the company's stock ticker symbol to the company profile's company identifier, (2) derived table 204 may map the company's universal name to the company profile's company identifier, (3) and derived table 206 may map the company's email domain to the company profile's company identifier.

In some embodiments, databus 212 may propagate writes to data replicator 122, which in turn propagates the writes to one or more other data centers.

Certain writes to master table 208 may not trigger any modifications at derived table 202-206. For example, if a member modifies a company attribute that is not a secondary key, none of the derived tables will need to be updated. On the other hand, if the write includes a modification to a secondary key, the derived table that corresponds to the secondary key may be updated. It should be noted, however, that the databus may take some time (e.g., ten minutes) to propagate the modification to the derived tables, which may result in the derived tables having stale data. To prevent the derived table from serving stale data, data center 110 may employ member cache 210 to implement sticky routing.

Member cache 210 may correspond to a web-based caching layer that implements a form of sticky routing by intercepting writes made by company API 106 to one of derived tables 202-206 and using a key-value store to temporarily cache modifications made by the writes. In some embodiments, the member cache may correspond to a Couchbase Server, which is a distributed non-relational document-oriented database.

When a member makes a modification to a company profile, if the write changes a secondary key, the member cache creates a cache entry that includes (1) the company identifier and (2) the new secondary key. The member cache associates the cache entry with the member's identifier. The cache entry is also assigned a time-to-live (TTL) value (e.g., ten minutes). When the TTL expires, the cache entry is invalidated and/or removed. As more modifications are made to secondary keys of company profiles stored in the master table, more cache entries may be created at the member cache. In some embodiments, writes to the master table may be intercepted by the member cache.

It should be noted that all modifications made by a particular member may be stored in a single cache entry. For example, if the member modifies a first secondary key of a company profile, the member cache may create a cache entry that includes the company identifier and the first secondary key. If the member then modifies a second secondary key of the company profile, the member cache, finding that a cache entry that is associated with the member's identifier already exists, may modify the cache entry to include the second secondary key.

In embodiments where a single member may manage multiple company profiles, all secondary key modifications made by a single member to different company profiles may be stored in a single cache entry. Returning to the above example, if the member then modifies a first secondary key of another company profile, the member cache, finding that a cache entry that is associated with the member's identifier already exists, may modify the cache entry to include both the company identifier and the first secondary key of the other company profile. In some embodiments, each time a cache entry is modified, the cache entry's TTL is reset.

In some embodiments, separate TTL's may be assigned to each secondary key stored in a cache entry. For example, if a cache entry is created due to a modification of a first secondary key and the cache entry is later modified to include a second secondary key due to a later modification, the first secondary key and the second secondary keys may expire at different times.

The data stored within these cache entries may be used to facilitate queries that specify secondary keys that were recently modified before databus propagates the modifications to derived tables 202-206. Such queries may be sent by company API 106 (shown in FIG. 1), which provides various “company finders” that enable clients to search for company profiles via various secondary keys. For example, company API 106 may provide (1) a findByUniversalName method that allows a client to search for a company profile by its universal name, (2) a findByEmailDomain method that allows a client to search for a company profile by its email domain, and (3) a findByStockSymbol method that allows a client to search for a company profile by its stock symbol.

Thus, if a query for a company profile that specifies a secondary key instead of a company identifier is sent to a derived table, the query may be intercepted by member cache 210. The member cache extracts the query's member's identifier and determines whether the member's identifier is associated with an entry in the cache. If no cache entry is associated with the member identifier, the query is forwarded to the derived table that corresponds to the specified secondary key, where the secondary key is translated to a primary key. Even if the company profile was recently modified, the member cache would not find an entry associated with the member's identifier if the member that initiated the query has not made any recent modifications.

If an associated cache entry is found, the member cache determines whether the cache entry includes the specified secondary key. If the cache entry does not include the specified secondary key, the query is forwarded to the derived table that corresponds to the specified secondary key. For example, the member that initiated the query may have made a modification to another company profile or a different secondary key of the company profile that the member is requesting. Here, while an entry associated with the member's identifier may exist, the entry would not include the specified secondary key.

If the cache entry does include the specified secondary key, the member cache may translate the specified secondary key to a primary key by (1) extracting the primary key associated with the company profile from the cache entry associated with the member's identifier and return (2) the primary key to the company API. The primary key may then be used to access the company profile at the master table.

FIG. 3 shows one or more exemplary data-structures used within a system that provides read-after-write consistency for derived non-relational data in accordance with the disclosed embodiments. In the illustrated embodiments, derived tables 202-204, master table 208, and member cache 210 are shown.

Master table 208 includes company profiles 302-306 (and other company profiles not shown in the figure) as records. Although not shown in the figure, it can be assumed that (1) company profile 302 has the universal name “abc-corp” and the stock ticker symbol “ABC,” (2) company profile 304 has the universal name “xyz-corp” and the stock ticker symbol “XYZ,” and (3) company profile 306 has the universal name “def-corp” and the stock ticker symbol “DEF.” Company profiles 302-306 have each been assigned a company identifier as a primary key, with ‘1’ referring to company profile 302, ‘2’ referring to company profile 304, and ‘3’ referring to company profile 306.

Derived table 202, which maps stock ticker symbols to company identifiers, is shown to include company identifiers ‘1’, ‘2’, and ‘3’ as records. Each of these records has been assigned a stock ticker symbol as a primary key, with “ABC” referring to ‘1’, “YYZ” referring to ‘2’, and “EEF” referring to ‘3’. Derived table 204, which maps universal names to company identifiers, is shown to include company identifiers ‘1’, ‘2’, and ‘3’ as records. Each of these records has been assigned a universal name as a primary key, with “bbc-corp” referring to ‘1’, “yyz-corp” referring to ‘2’, and “def-corp” referring to ‘3’.

Member cache 210, which maps member identifiers to cache entries, is shown to include two cache entries. In some embodiments, each member of the user community may be assigned a unique member identifier when the member first joins the community. The first cache entry (the middle box), which is associated with member identifier ‘77’, caches modifications made by member 77 to the company profile referred to by company identifier (CID) ‘2’, which is company profile 304. In particular, member 77 modified company profile 304's universal name (uname) from “yyz-corp” to “xyz-corp” and the profile's stock ticker symbol (ssymbol) from “YYZ” to “XYZ.” As shown by the TTL in the entry, assuming that each new cache entry is assigned a TTL of ten minutes, member 77 made her latest modification one minute ago (the modifications to the two attributes may have been made in two separate writes, wherein the TTL is updated in response to the latest write).

The second cache entry (the rightmost box), which is associated with member identifier ‘76’, records modifications made by member 76 to the company profile referred to by company identifier ‘1’, which is company profile 302, and the company profile referred to by company identifier ‘3’, which is company profile 306. In particular, member 76 modified company profile 302's universal name from “bbc-corp” to “abc-corp” and company profile 306's stock ticker symbol from “EEF” to “DEF.” As shown by the TTL in the entry, member 76 made her latest modification 2 minutes ago.

As explained above, the data stored in member cache 210 and derived tables 202-204 are used to facilitate the retrieval of the company profiles for queries that specify a secondary key rather than a primary key. For instance, the dashed arrows in FIG. 3 each indicate that company profile 302's company identifier is stored at the member cache and the derived tables. Thus, if a query that specifies one of company profile 302's secondary keys is received, the secondary key may be translated to company profile 302's identifier at either member cache 210 or one of derived tables 202-204. The company identifier may then be used to access company profile 302 at master table 208.

It should be noted, however, that derived tables 202-204 contain stale data. As can be seen from the contents of master table 208 and member cache 210, the “YYZ” and “EEF” entries in derived table 202 and the “bbc-corp” and “yyz-corp” entries in derived table 204 are stale. Eventually, the modifications made by member 76 and member 77 will be propagated by databus 212 (shown in FIG. 2) to the derived tables, which will cause primary keys “YYZ” and “EEF” in derived table 202 to be changed to “XYZ” and “DEF” respectively, and primary keys “bbc-corp” and “yyz-corp” to be changed to “abc-corp” and “xyz-corp” respectively.

In read-after-write scenarios that include modifications to universal names and/or stock ticker symbols of company profiles, the subsequent query may arrive before the modifications are propagated to the derived tables. For example, member 77, who just modified company profile 304's universal name from “yyz-corp” to “xyz-corp”, initiates a findByUniversalName method call that uses “xyz-corp” as a parameter. If derived table 204 were to handle the query initiated by the findByUniversalName call, the derived table would indicate that no company profile with the universal name “xyz-corp” exists. Therefore, having member cache 210 intercept the query prevents the derived table from serving stale data and degrading the member's user experience (e.g., wherein the member is not able to view the newly modified company profile until ten minutes have passed).

When member cache 210 intercepts the query, the member cache extracts the member's identifier from the query, which is ‘77’. The member cache then retrieves the cache entry referred to by ‘77’ and determines whether “xyz-corp” is found in the cache entry. Because “xyz-corp” is found in the cache entry, the member cache extracts the company identifier stored in the cache entry, which is ‘2’, and returns the company identifier in response to the query. The company identifier ‘2’ is then used to access company profile 304 at master table 208.

In some embodiments, after a secondary key is modified but prior to propagation, the member cache may allow members that did not make the modification to continue using the old secondary key until the modification is propagated. For example, if a member other than member 77 makes a request to read company profile 304 with the old universal name “yyz-corp,” member cache intercepts the query and extracts the member's identifier from the query. Once the member cache determines that either (1) the member's identifier is not associated with a cache entry (i.e., the member hasn't made any recent writes to the master table) or (2) the member's identifier is associated with a cache entry but the cache entry does not match “yyz-corp,” the member cache forwards the query to derived table 204. Derived table 204 determines that “yyz-corp” refers to the record containing company identifier ‘2’, and returns the company identifier in response to the query. The company identifier ‘2’ is then used to access company profile 304 at master table 208. After the modification is propagated to the derived tables, the new secondary key may be made available all members.

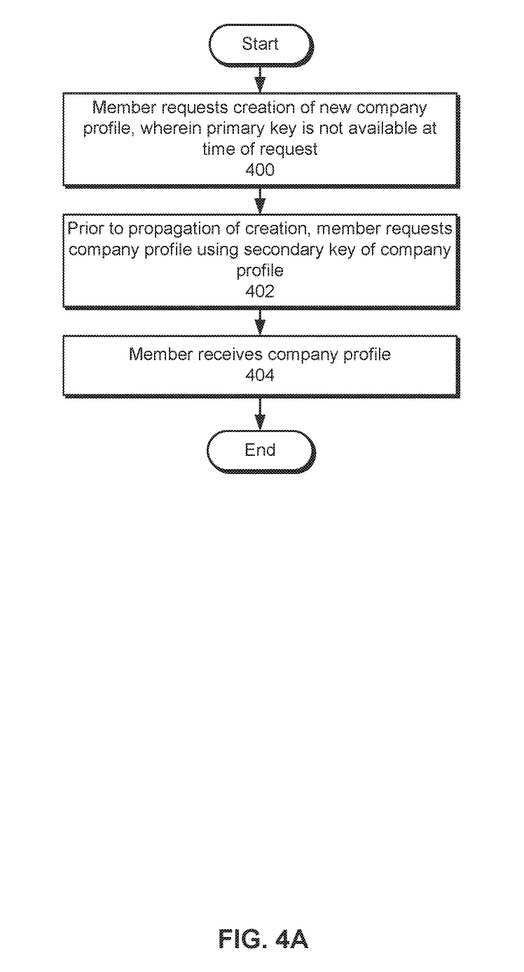

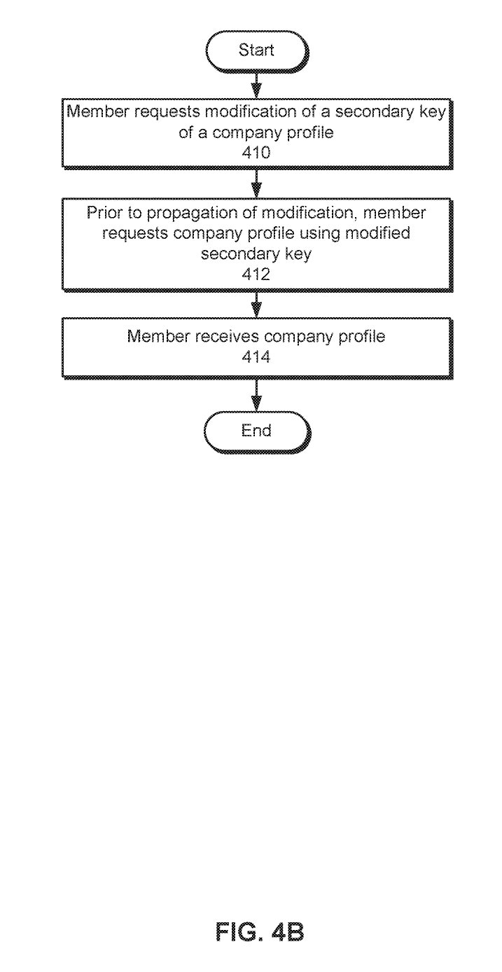

FIG. 4A shows a flowchart illustrating an exemplary process of reading data associated with an entity after creating the entity in accordance with the disclosed embodiments. In one or more embodiments, one or more of the steps may be omitted, repeated, and/or performed in a different order. Accordingly, the specific arrangement of steps shown in FIG. 4A should not be construed as limiting the scope of the embodiments.

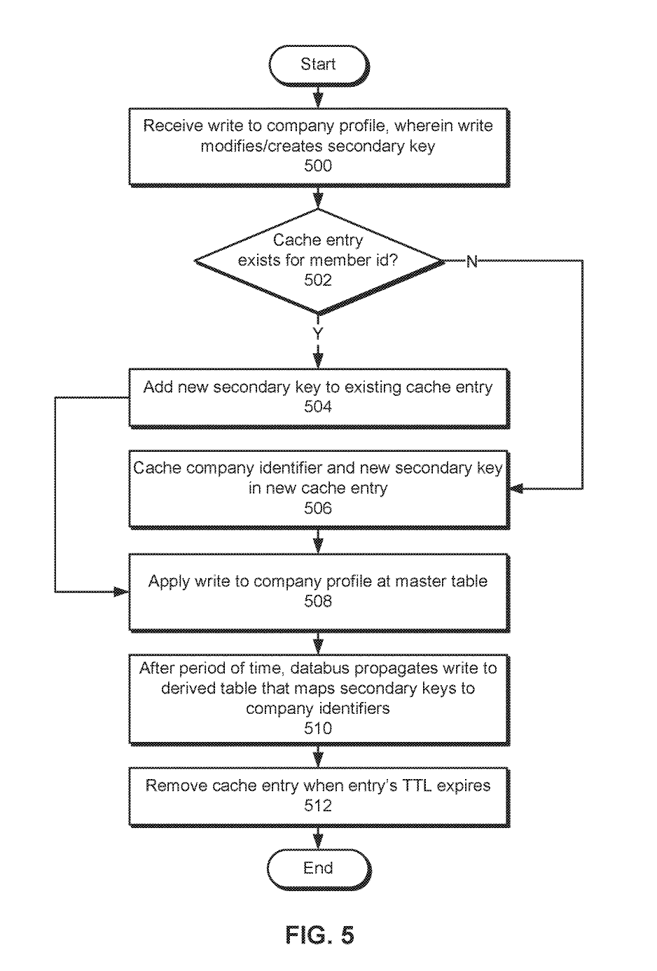

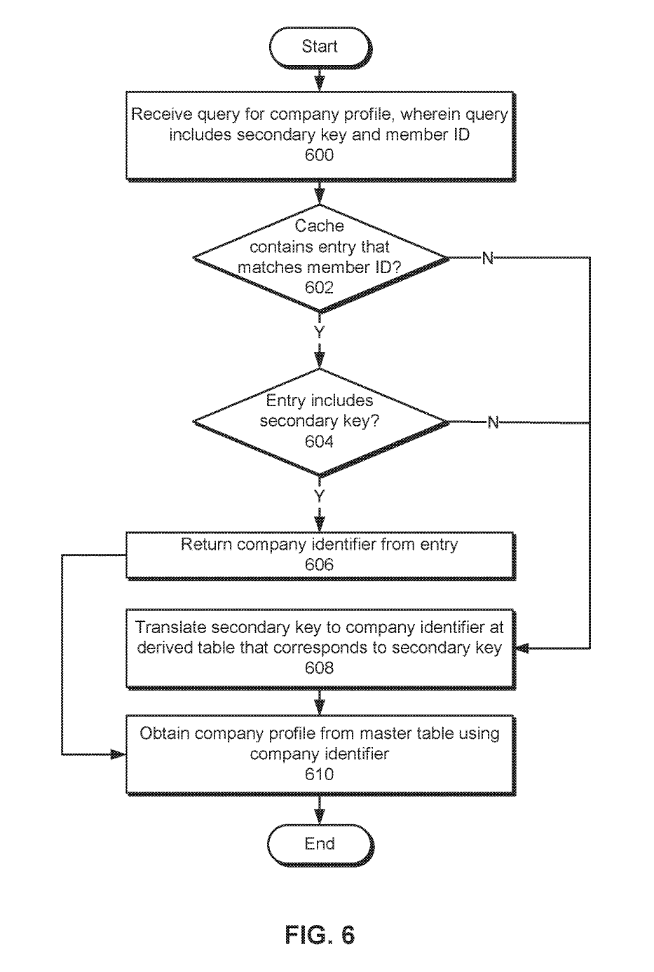

Initially, a member requests the creation of a new company profile at a non-relational database (operation 400), wherein the member may not have access to the primary key (e.g., the company identifier) before the creation is propagated throughout a distributed data storage system that includes the non-relational database. Prior to propagation, the member attempts to view the newly created company profile, wherein the resulting query to the non-relational database is made with a secondary key of the company (operation 402). The member then receives the company profile that corresponds to the secondary key from the non-relational database (operation 404). The handling of queries and writes by the non-relational database are discussed in further detail below with respect to FIGS. 5-6.

FIG. 4B shows a flowchart illustrating an exemplary process of reading data associated with an entity after modifying one or more attributes of the entity in accordance with the disclosed embodiments. In one or more embodiments, one or more of the steps may be omitted, repeated, and/or performed in a different order. Accordingly, the specific arrangement of steps shown in FIG. 4B should not be construed as limiting the scope of the embodiments.

Initially, a member requests to modify a secondary key of an existing company profile at a non-relational database (operation 410). Before the modification is propagated, the member attempts to view the modified company profile, wherein the resulting query to the non-relational database includes the modified secondary key (operation 412). The member then receives the company profile that corresponds to the modified secondary key from the non-relational database (operation 414). The handling of queries and writes by the non-relational database are discussed in further detail below with respect to FIGS. 5-6.

FIG. 5 shows a flowchart illustrating an exemplary process of writing to data associated with an entity in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

Initially, a write is received by the non-relational database, wherein the write requests (1) the creation of a new company profile with one or more secondary keys at the master table or (2) a modification to one or more secondary keys of an existing company profile at the master table (operation 500). The modifications applied by the write are stored at a member cache. If a cache entry that corresponds to the member that initiated the write already exists in the member cache (decision 502), the one or more new secondary keys are added to the cache entry (operation 504) and the cache entry's TTL is reset. Otherwise, a new cache entry is created at the member cache (operation 506), wherein the cache entry includes the company identifier of the company profile and the one or more new secondary keys. Next, the write is applied to the company profile in the master table (operation 508). After a period of time, a databus service propagates the write to other tables derived from the master table, wherein each derived table maps secondary keys to company identifiers (operation 510). Eventually, the cache entry is removed from the member cache when the cache entry expires (operation 512).

FIG. 6 shows a flowchart illustrating an exemplary process of reading data associated with an entity in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

Initially, a query for a particular company profile is received by the non-relational database, wherein the query includes a secondary key of the company and the identifier of the member that initiated the query (operation 600). Once the query is intercepted by the member cache, if (1) the member cache contains a cache entry that matches the member identifier (decision 602) and (2) the matching cache entry includes the secondary key (decision 604), the member cache returns the company identifier stored in the cache entry in response to the query (operation 606). Otherwise, the query is forwarded to a derived table that corresponds to the secondary key, wherein the secondary key is translated to the company identifier at the derived table (operation 608). Eventually, the company identifier is used to retrieve a company profile from the master table (operation 610).

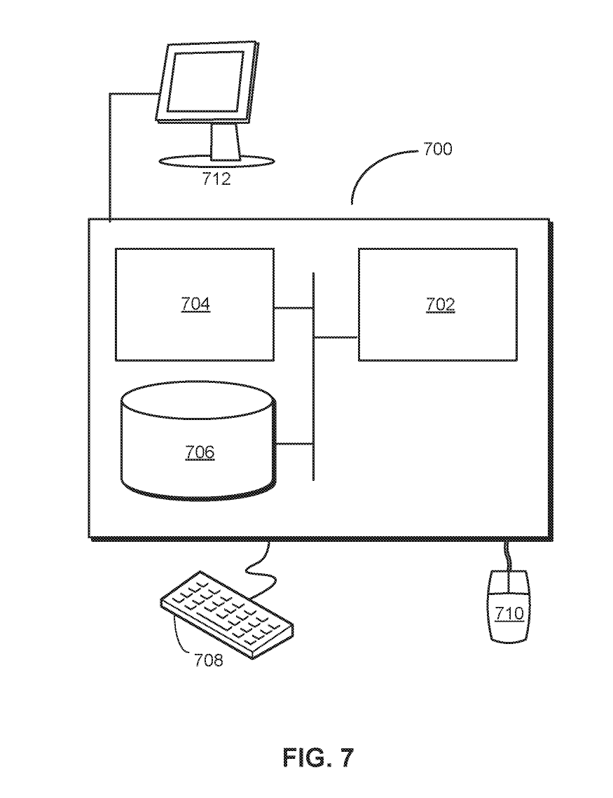

FIG. 7 shows a computer system 700 in accordance with an embodiment. Computer system 700 may correspond to an apparatus that includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system that that ensures read-after-write consistency when retrieving data from non-relational databases based on derived non-relational data in environments with multiple colocations. The system may include a non-relational database apparatus or module that receives a write for a first record, wherein the first record is associated with a primary key at a master non-relational database table and the write specifies a secondary key for the first record. The database apparatus may cache both keys in an entry cache, wherein the entry is associated with the user that initiated the write. The database apparatus may then apply the write to the master table.

The system may include a data replication apparatus or module that propagates the write to one or more other non-relational database tables that are derived from the master table. However, prior to the data replication apparatus propagating the write to a derived table that maps secondary keys to primary keys, the database apparatus may receive a query, wherein the query includes the first secondary key. If the user that initiated the query is the user that initiated the write, the database apparatus may translate the first secondary key to the first primary key by querying the cache. Otherwise, the database apparatus may instead perform the translation by querying the derived table.

In addition, one or more components of computer system 700 may be remotely located and connected to the other components over a network. Portions of the present embodiments (e.g., application apparatus, controller apparatus, data processing apparatus, etc.) may also be located on different nodes of a distributed system that implements the embodiments. For example, the present embodiments may be implemented using a cloud computing system that manages the profiling of one or a plurality of machines that execute one or more instances of a software application.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
receiving, from a first user, a write to a first record having a first primary key in a master key-value store, wherein the write specifies a first secondary key for the first record;
caching the first secondary key and the first primary key in a first cache entry in a cache, wherein the first cache entry is associated with the first user;
applying the write to the master key-value store;
prior to propagation of the write from the master key-value store to a derived key-value store that maps secondary keys to primary keys, receiving from a given user a query for the first record, the query comprising the first secondary key and not the first primary key; and
translating the first secondary key to the first primary key by:
when the given user is the first user, querying the cache; and
when the given user is not the first user, querying the derived key-value store.

2. The method of claim 1, wherein associating the first cache entry with the first user comprises:
extracting from the write a first identifier of the first user; and
including the first identifier in the first cache entry.

3. The method of claim 2, wherein said translating comprises:
extracting from the query a given identifier of the given user;
determining whether the cache layer includes an entry comprising the given identifier; and
when the cache layer includes an entry comprising the given identifier:
determining whether the cache entry comprises the first secondary key; and
when the secondary key of the cache entry comprises the first secondary key, retrieving the primary key of the cache entry.

4. The method of claim 1, wherein applying the write to the master key-value store comprises one of:
replacing an existing secondary key of the first record with the first secondary key; and
creating the first record with the first secondary key and associating the first record with the first primary key in the master key-value store.

5. The method of claim 1, further comprising, subsequent to the application of the write to the master key-value store but prior to the propagation of the write to the derived key-value store:
receiving from a second user a second query for the first record, the second query comprising the first secondary key and not the first primary key;
determining that no cache entry in the cache that comprises the secondary key is associated with the second user; and
attempting to translate the first secondary key to the first primary key at the derived key-value store, wherein the first secondary key is not found in the derived key-value store.

6. The method of claim 1, wherein:
the master key-value store and the derived key-value store are Espresso tables;
each record is an Espresso document; and
one or more Databus change events propagate the write to the derived key-value store.

7. The method of claim 1, wherein:
each record in the master key-value store corresponds to a company; and
the secondary key corresponds to one of:
a universal name of the company;
an email domain of the company; and
a stock symbol of the company.

8. The method of claim 1, further comprising, retrieving the first record from the master key-value store with the first primary key and returning the first record to the first user.

9. An apparatus, comprising:
one or more processors; and
memory storing instructions that, when executed by the one or more processors, cause the apparatus to:
receive, from a first user, a write to a first record having a first primary key in a master key-value store, wherein the write specifies a first secondary key for the first record;
cache the first secondary key and the first primary key in a first cache entry in a cache, wherein the first cache entry is associated with the first user;
apply the write to the master key-value store;
prior to propagation of the write from the master key-value store to a derived key-value store that maps secondary keys to primary keys, receive from a given user a query for the first record, the query comprising the first secondary key and not the first primary key; and
translate the first secondary key to the first primary key by:
when the given user is the first user, querying the cache; and
when the given user is not the first user, querying the derived key-value store.

10. The apparatus of claim 9, wherein associating the first cache entry with the first user comprises:
extracting from the write a first identifier of the first user; and
including the first identifier in the first cache entry.

11. The apparatus of claim 10, wherein said translating comprises:
extracting from the query a given identifier of the given user;
determining whether the cache layer includes an entry comprising the given identifier; and
when the cache layer includes an entry comprising the given identifier:
determining whether the cache entry comprises the first secondary key; and
when the secondary key of the cache entry comprises the first secondary key, retrieving the primary key of the cache entry.

12. The apparatus of claim 9, wherein applying the write to the master key-value store comprises one of:
replacing an existing secondary key of the first record with the first secondary key; and
creating the first record with the first secondary key and associating the first record with the first primary key in the master key-value store.

13. The apparatus of claim 9, wherein subsequent to the application of the write to the master key-value store but prior to the propagation of the write to the derived key-value store, the apparatus is further caused to:
receive from a second user a second query for the first record, the second query comprising the first secondary key and not the first primary key;
determine that no cache entry in the cache that comprises the secondary key is associated with the second user; and
attempt to translate the first secondary key to the first primary key at the derived key-value store, wherein the first secondary key is not found in the derived key-value store.

14. The apparatus of claim 9, wherein:
the master key-value store and the derived key-value store are Espresso tables;
each record is an Espresso document; and
one or more Databus change events propagate the write to the derived key-value store.

15. The apparatus of claim 9, wherein:
each record in the master key-value store corresponds to a company; and
the secondary key corresponds to one of:
a universal name of the company;
an email domain of the company; and
a stock symbol of the company.

16. The apparatus of claim 9, wherein the apparatus is further caused to retrieve the first record from the master key-value store with the first primary key and returning the first record to the first user.

17. A system, comprising:
one or more processors;
an database module comprising a non-transitory computer-readable medium storing instructions that, when executed, cause the system to:
receive, from a first user, a write to a first record having a first primary key in a master key-value store, wherein the write specifies a first secondary key for the first record;
cache the first secondary key and the first primary key in a first cache entry in a cache, wherein the first cache entry is associated with the first user;
apply the write to the master key-value store;
prior to propagation of the write from the master key-value store to a derived key-value store that maps secondary keys to primary keys, receive from a given user a query for the first record, the query comprising the first secondary key and not the first primary key; and
translate the first secondary key to the first primary key by:
when the given user is the first user, querying the cache; and
when the given user is not the first user, querying the derived key-value store.

18. The system of claim 17, wherein associating the first cache entry with the first user comprises:
extracting from the write a first identifier of the first user; and
including the first identifier in the first cache entry.

19. The system of claim 17, wherein said translating comprises:
extracting from the query a given identifier of the given user;
determining whether the cache layer includes an entry comprising the given identifier; and
when the cache layer includes an entry comprising the given identifier:
determining whether the cache entry comprises the first secondary key; and
when the secondary key of the cache entry comprises the first secondary key, retrieving the primary key of the cache entry.

20. The system of claim 17, wherein applying the write to the master key-value store comprises one of:
replacing an existing secondary key of the first record with the first secondary key; and
creating the first record with the first secondary key and associating the first record with the first primary key in the master key-value store.
